(19) United States
(12) Patent Application Publication
(10) Pub. No.: US 2024/0424973 A1
(43) Pub. Date: Dec. 26, 2024

(54) A TOWING DEVICE

(71) Applicant: BS ENGINEERING APS, Hinnerup (DK)

(72) Inventor: Brian Printz SØRENSEN, Brabrand (DK)

(21) Appl. No.: 18/708,218

(22) PCT Filed: Nov. 24, 2022
(86) PCT No.: PCT/DK2022/000255

§ 371 Date: May 8, 2024

(30) Foreign Application Priority Data
Nov. 24, 2021 (DK) PA 2021 01114

(51) Int. Cl. B60P 3/07

(52) U.S. Cl. CPC B60P 3/07

(57) ABSTRACT

A towing device 100 for moving a, vehicle from a first location to a second location is described. The towing device, in the orientation intended during use, comprises a frame 2, wherein said frame comprises one or more sets of wheels 4 to be supported on a ground surface 6; —wherein said frame 2 comprises a support surface 8 at an upper portion 10 thereof, wherein said support surface 8 is having an extension in a longitudinal direction (X) and in a transversal direction (Y), which is perpendicular to said longitudinal direction; —wherein said support surface 8 is having a longitudinal front end 12 and a longitudinal rear end 14, wherein said support surface is being configured to be arranged below a vehicle 200 and support said vehicle to be moved; wherein said towing device comprises propulsion means 16 for propelling said towing device; wherein said towing device comprises a control system 18 for controlling the operation of said towing device; wherein said towing device comprises lifting means 20 for raising and lowering said support surface 8 in relation to said ground surface 6.

### FIELD OF THE INVENTION

The present invention generally relates to the field of towing vehicles. In a first aspect the present invention relates to a towing device for moving a vehicle from a first location to a second location. In a second aspect the present invention relates to the use of a towing device according to the first aspect for moving a vehicle. In a third aspect the present invention relates to a method for moving a vehicle from a first location to a second location.

### BACKGROUND OF THE INVENTION

From time to time, situations occur in which a vehicle has been left by being parked on a property where it is not allowed to park or even will block access to entrances or exits to other premises. Such a situation may impair the conduct of traffic in an efficient way and in order to restore an efficiently conducted traffic and in order to keep the space free where no vehicles are allowed to park, the owner of the property or the authorities will in such situations provide for removing such a vehicle by towing it away.

To this end a towing truck is used. A towing truck is a type of a rather large vehicle which is equipped with towing means that can be engaged with the vehicle to be towed. The towing means may comprise a frame that can lift the front or the rear pair of wheels of the vehicle from underneath. Another example of towing means is in form of a wire winch with a wire that can be attached to the vehicle to be towed.

Although such towing trucks in many situations are capable of solving the problem of towing away a vehicle, limitations to this technology nevertheless exist.

These limitations primarily relate to the fact that, in order to have a towing truck tow away another vehicle, a rather large amount of free space is needed around the vehicle to be towed so that the towing truck can be placed in near vicinity of the vehicle to be towed.

Such limited space around a vehicle to be towed away is especially encountered in underground parking lots or in carpark buildings where vehicles typically are being parked in very confined spaces at two opposing sides of an aisle connecting the entrance with the exit of the parking lot.

Due to the confined space in such underground parking lots or carpark buildings, it will always almost be impossible for the prior art towing trucks to tow away a vehicle parked at such places or even to have the towing truck arrive at such location due to limitations of free height in such parking lots.

A prior art document CN212201495U of SHUNDE POLYTECHNIC discloses an omnidirectional vehicle for transferring passenger vehicles, which comprises an omnidirectional vehicle body, the omnidirectional vehicle body is provided with a frame, and two sides of the bottom of the frame are connected with a plurality of wheels. An electric control box is arranged on one side of the frame, the electric control box is arranged between the wheels, a jacking mechanism is arranged on the top of the frame, a tray is connected to the top of the jacking mechanism, and the jacking mechanism A slide rail is provided, the top of the slide rail is connected with a support rod, the inner side of the support rod is provided with a lead screw, and the top of the support rod is provided with a lift rod. The utility model is an omnidirectional transfer device based on the Mecanum wheel. It is applied to the fast moving in and out of the passenger car in the garage to improve the efficiency of accessing the car and save the garage space. It can also be used for the efficient transfer of passenger cars in other similar occasions, which can make up for the traditional garage rail-type moving.

CN 111 173 338 A discloses a parking and carrying platform which allows for remote controlled maneuvering of vehicles in parking operations involving confined spaces, such as in parking garages. The parking and carrying platform comprises an upper platform and a lower platform and a lifting assembly for lifting the upper platform in relation to the lower platform. The lower platform comprises two sets of wheels which are being propelled by a propulsion motor. A platform motor allows for changing the configuration of the lifting assembly so as to bring the upper platform and the lower platform further apart or closer to each other. In use, a driver exits the vehicle to be parked and uses a remote control to steer the parking and carrying platform under the vehicle with the two plat forms sufficiently close to each other. Subsequently, the platform motor is engaged in order to bring the upper platform and the lower platform further apart, thereby lifting the whole vehicle or the rear part thereof. With the vehicle so lifted, the driver can use the remote control to maneuver the vehicle into a confined parking lot. Finally, the vehicle can be lowered again by bringing the two platforms closer to each other. CN 111 173 338 A does not disclose that one end of the upper platform can be raised and lowered independently of an opposite end of that platform.

WO 2019/148237 A1 discloses a trailer for transporting a vehicle. The trailer comprises a support surface for supporting the wheels of the vehicle to be transported. The trailer also comprises two sets of wheels which are suspending in each individual wheel suspension. Each wheel suspension can raise or lower the set of wheels suspended therein. As the support surface of the trailer is for supporting the wheels of the vehicle to be transported, the support surface of the trailer is too large to be positioned at a position below the vehicle to be transported without also moving that vehicle. Hence, this document relates to a trailer on top of which a vehicle can be rolled on, rather than a to device to be placed below a vehicle.

CN 214 246 707 U discloses a vehicle lifting device for enabling lifting of vehicle from a ground floor to a floor above in a parking garage. The vehicle lifting device comprises a chassis with four wheels, a support frame for supporting a vehicle and a motor. The support frame can be lifted to a predetermined height. CN 214 246 707 U does not explicitly disclose that the vehicle lifting device comprises steering means allowing for steering the device in a sideways direction.

Another and much more severe and hazardous problem associated with vehicles being parked in underground parking lots or in carpark buildings arise when a vehicle in such a parking lot catches fire. In a case where a fire in a burning vehicle is not being extinguish rather fast, there is a profound risk that the fire will spread to other cars like a chain reaction. Once such a fire is spreading there is a risk that all vehicles of the underground parking lot or the carpark building will burn out and even worse, such a huge fire may impart structural damages to the building itself which houses the parking lot.

Statistics reveal that electric vehicles have a larger tendency to self-ignite and catch fire, compared to more traditional vehicle being propelled by a combustion engine, and with the ever increasing popularity of electric vehicles, the hazards of burning vehicles in confined parking lots are increasing.

Accordingly, a need persists for an improved and more flexible technology for towing away a vehicle.

It is an objective of the present invention to provide such technology.

### BRIEF DESCRIPTION OF THE INVENTION

This objective is fulfilled according to the present invention in its various aspects.

Accordingly, the present invention relates in a first aspect to a towing device for moving a vehicle from a first location to a second location;
wherein said towing device, in the orientation intended during use, comprises:
a frame, wherein said frame comprises one or more sets of wheels to be supported on a ground surface;
wherein said frame comprises a support surface at an upper portion thereof, wherein said support surface is having an extension in a longitudinal direction X and in a transversal direction Y, which is perpendicular to said longitudinal direction;
wherein said support surface is having a longitudinal front end and a longitudinal rear end, wherein said support surface is being configured to be arranged below a vehicle and support said vehicle to be moved;
wherein said towing device comprises propulsion means for propelling said towing device;
wherein said towing device comprises a control system for controlling the operation of said towing device;
wherein said towing device comprises lifting means for raising and lowering said support surface in relation to said ground surface;
wherein said towing device comprises drive means in the form of a first set of drive wheels or drive caterpillars arranged at a right side of the towing device and a second set of drive wheels or drive caterpillars arranged at a left side of the towing device;
characterized in that said lifting means comprises a first set of lifting means which is configured for lifting/lowing the longitudinal front end of said support surface; and wherein said lifting means comprises a second set of lifting means which is configured for lifting/lowing the longitudinal rear end of said support surface;
and in that said first set of lifting means comprises a wheel suspension which is being pivotally mounted to said frame and wherein one or more actuators are being mounted between said wheel suspension and said frame in such a way that actuation of said one or more actuators will effect a pivoting of said wheel suspension around a pivot axis.

In a second aspect the present invention relates to a use of a towing device according to the first aspect of the invention for moving a vehicle from a first location to a second location.

In a third aspect the present invention relates to a method for moving a vehicle from one location to another location; said method comprises the steps of:
i) providing a towing device according to the first aspect of the present invention;
ii) arranging the towing device in line with the longitudinal direction of the vehicle to be moved, either in front of or behind that vehicle;
iii) ensuring that the support surface is being arranged in a lowered configuration;
iv) using said control system of said towing device to propel and steer said device in order to arrange said support surface, or at least part thereof, of the device below said vehicle to be moved;
v) once arranged below said vehicle to be moved, via said control system, raising said support surface a predetermined distance by means of said lifting means;
vi) using said control system of said towing device to propel and steer said towing device in order to move said vehicle from a first location to a second location.

### BRIEF DESCRIPTION OF THE FIGURES

FIG. 1 is a side view illustrating the towing device according to the first aspect of the present invention with its support surface in its raised configuration.

FIG. 2 is a side view illustrating the towing device according to the first aspect of the present invention with its support surface in its lowered configuration.

FIG. 3 is a schematic diagram illustrating the working mode of controlling the towing device according to the invention.

FIG. 4 is a perspective view of the towing device of FIGS. 1 and 2 illustrating details of the first set of lifting means.

FIG. 5 is a perspective view of the towing device according to the first aspect of the present invention in which the towing device has been provided with wheel supports.

FIG. 6 is a top view of the embodiment illustrated in FIG. 5.

FIG. 7 is a perspective view illustrating details of a first kind of wheel support to be attached to the frame of the towing device.

FIG. 8 is a perspective view illustrating details of a second kind of wheel support to be attached to the frame of the towing device.

FIG. 9 is a perspective view illustrating the presence and position of two receiving organs for auxiliary wheel assemblies at a lower part of the wheel suspension of the frame of the towing device.

FIG. 10 is a perspective view illustrating a towing device with its wheel suspension provided with two auxiliary wheel assemblies at a lower part thereof.

FIG. 11 is a side view illustrating a towing device with its wheel suspension provided with an auxiliary wheel assembly at a lower part thereof.

FIG. 12 is a perspective view illustrating an auxiliary wheel assembly to be mounted onto the wheel suspension of the frame of the towing device.

FIG. 13 is a perspective view illustrating the presence and position of two auxiliary actuators with their associated respective pivoting elements at the wheel suspension of the frame of the towing device in their expanded configuration.

FIG. 14 is a perspective view illustrating the presence and position of two auxiliary actuators with their associated respective pivoting elements at the wheel suspension of the frame of the towing device in their compressed configuration.

### DETAILED DESCRIPTION OF THE INVENTION

### The First Aspect of the Present Invention

The present invention relates in a first aspect to a towing device for moving a vehicle from a first location to a second location;
wherein said towing device, in the orientation intended during use, comprises:
a frame, wherein said frame comprises one or more sets of wheels to be supported on a ground surface;
wherein said frame comprises a support surface at an upper portion thereof, wherein said support surface is having an extension in a longitudinal direction (X) and in a transversal direction (Y), which is perpendicular to said longitudinal direction;
wherein said support surface is having a longitudinal front end and a longitudinal rear end, wherein said support surface is being configured to be arranged below a vehicle and support said vehicle to be moved;
wherein said towing device comprises propulsion means for propelling said towing device;
wherein said towing device comprises a control system for controlling the operation of said towing device;
wherein said towing device comprises lifting means for raising and lowering said support surface in relation to said ground surface;
wherein said towing device comprises drive means in the form of a first set of drive wheels or drive caterpillars arranged at a right side of the towing device and a second set of drive wheels or drive caterpillars arranged at a left side of the towing device;
characterized in that said lifting means comprises a first set of lifting means which is configured for lifting/lowing the longitudinal front end of said support surface; and wherein said lifting means comprises a second set of lifting means which is configured for lifting/lowing the longitudinal rear end of said support surface;
and in that said first set of lifting means comprises a wheel suspension which is being pivotally mounted to said frame and wherein one or more actuators are being mounted between said wheel suspension and said frame in such a way that actuation of said one or more actuators will effect a pivoting of said wheel suspension around a pivot axis.

Accordingly, in the first aspect of the present invention is provided a towing device which allows for arranging a support surface beneath a vehicle to be towed away, wherein the support surface upon arrangement beneath the vehicle is in a lowered configuration and which allows for raising the support surface so that the wheels of the vehicle are being lifted from the ground. In this raised configuration it will be possible to move the towing device and thereby also the vehicle to be towed away. The types of drive means involved ensure that the towing device can be moved around on the ground.

Besides, the two independent lifting means allows for a more accurate positioning of the vehicle onto the support frame and also allows for improved balancing the vehicle to be towed onto the support frame in case the ground over which the vehicle is to be towed is having a rather steep inclination.

The way of designing the first set of lifting means provides a compact set of lifting means which can be accommodated in a rather confined space at the frame of and under the support surface of the device.

In the present description and in the appended claims the term “towing a vehicle” may be construed to mean moving a vehicle over ground without the use of the vehicle's own propulsion means.

In the present description and in the appended claims the term “longitudinal front end of the towing device” may be construed to mean a free end of the towing device, the access to which is not obstructed by propulsion means or the like of the towing device.

In one embodiment of the towing device according to the present invention, said control system is being configured for receiving input from an operator; and wherein said control system, based on said input, is being configured to provide control instructions to said propulsion means and to said lifting means for control thereof.

Hereby is ensured adequate control of parameters relating to movement over ground of the towing device as well as relating to raising and lowering the support surface of the device.

In one embodiment of the towing device according to the present invention, said said towing device comprises a remote control comprising a transmitter for transmitting electromagnetic radiation representing control instructions, and wherein said control system comprises a receiver for receiving electromagnetic radiation representing said control instructions.

Hereby is insured that the towing device can be controlled by an operator which is located at a safety distance to the device itself. This is highly desirable, in case of a vehicle to be towed has caught fire.

In one embodiment of the towing device according to the present invention, said towing device comprises one or more image capturing units which is/are each configured to capture images and wherein said towing device comprises a transmitter for transmitting electromagnetic radiation representing said images; wherein said remote control comprises a receiver configured to receive said electromagnetic radiation representing said images, and wherein said remote control comprises a display which is being configured to display one or more of the images represented by said electromagnetic radiation.

Such image capturing units will aid an operator operating the towing device in case of poor lighting conditions and may also generally provide better visual information to the operator relating to positioning of the towing device relative to the vehicle to be towed.

In one embodiment of the towing device according to the present invention, said propulsion means is in the form of one or more electric motors wherein said towing device comprises one or more electric energy storages, such as one or more batteries for powering said one or more electric motors.

It is preferred to provide for galvanic insulation between the support surface of the frame onto which a vehicle is be placed and one or more of the electric and/or electronic components of the towing device, such as the control system, the propulsion means, and batteries. Such galvanic insulation may be provided by arranging such electric and/or electronic components onto electrically insulating pads or bushings, such as rubber pads or rubber bushings on the towing device.

In this way, in case an electric discharge occurs in the vehicle being towed, such discharge will not detrimentally influence the movement of the towing device.

In one embodiment of the towing device according to the present invention, said lifting means comprises one or more actuators, such as electric, mechanical or hydraulic actuators, which via said control system are configured to be able to change configuration between an expanded configuration and a collapsed configuration, and thereby effect raising or lowering of said support surface in relation to said ground surface.

Such actuators have proven beneficial for raising and lowering the support surface of the towing device.

In one embodiment of the towing device according to the present invention, the towing device comprises a winch, such as a motorised winch, including a wire for attachment to the vehicle to be moved and thereby securing that vehicle on top of the support surface of the towing device and/or for aiding in bringing that vehicle on top of said support surface.

A winch with a wire will in some instances be beneficial in that it may assist in arranging the vehicle to be towed away onto the support surface and it may additionally secure the vehicle on top of the support surface.

In one embodiment of the towing device according to the present invention, the support surface of the towing device, at a longitudinal front end, comprises an inclined platform part, which in a predetermined distance, is inclined downward, in a longitudinal direction, compared to the inclination of the rest of the support surface.

Such an inclined surface will allow for bringing a vehicle to be towed away onto the support surface, by means of a winch and wire, even though the support surface has not previously be arranged beneath the vehicle.

It is noted, that generally the support surface, or at least part thereof, of the frame of the towing device is in the form of a support platform, such as a flat support platform.

In one embodiment of the towing device according to the present invention, the control system for controlling the operation of said towing vehicle is configured for steering said towing device by effecting a higher or lower rotation of said first set of drive wheels or drive caterpillars relative to said second set of drive wheels or drive caterpillars.

In one embodiment of the towing device according to the present invention, the propulsion means is being integrated with said frame.

Hereby a rather compact towing device may be attained.

In one embodiment of the towing device according to the present invention, the propulsion means is in the form of a propulsion cart which is being separatable from said frame.

Such separate propulsion carts are commercially available and can be modified so as to fit coupling to a frame having the features of the frame of the towing device as defined in this application.

In one embodiment of the towing device according to the present invention, the propulsion cart comprises a first coupling means and wherein said frame comprises a second coupling means; wherein said first coupling means and said second coupling means are being configured to be able to enter into releasable engagement with each other.

In one embodiment of the towing device according to the present invention, the first coupling means comprising the male part of a standard coupling means or hiss for attaching a trailer to a passenger car; and wherein said second coupling means comprising the female part of a standard coupling means or hiss for attaching a trailer to a passenger car.

According to these two embodiments the frame of the towing device can be separated from the propulsion cart which allows for easier transport thereof.

In one embodiment of the towing device according to the present invention, the actuation of said one or more actuators will effect a pivoting of said wheel suspension around a pivot axis, which is being perpendicular to the longitudinal direction of said support surface.

In one embodiment of the towing device according to the present invention, the frame at a longitudinally arranged beam at its right side and/or at its left side thereof comprises an auxiliary actuator having a first end and a second end, such as a hydraulic actuator or an electric actuator; said auxiliary actuator is being configured to be able to change its configuration between a compressed configuration and an expanded configuration and vice versa, by actuation thereof;
wherein said frame at said longitudinally arranged beam at its right side and/or at its left side thereof comprises a pivoting element; wherein said pivoting element is being mounted onto an inner side of said longitudinally arranged beam of said frame so as to be able to pivot around a pivoting axis; wherein said pivoting element comprises a push portion;
wherein said first end of said auxiliary actuator is being pivotally fastened to said frame and wherein the second end of said auxiliary actuator is being pivotally fastened to said pivotally element in such a way that in a situation where the longitudinal front end is in its lowered configuration, then a change in configuration of said auxiliary actuator from its compressed configuration to its expanded configuration will allow said push portion of said pivoting element, such as either directly or indirectly, to push onto said wheel suspension in a downward direction, thereby aiding the actuator in its initial movement upon lifting said support surface in relation to the ground surface.

Such an auxiliary actuator will aid in effecting an initial pivoting of the wheel suspension in order to make it easier for the actuators to effect the remainder of the pivoting of the wheel suspension.

In one embodiment of the towing device according to the present invention, the push portion of said pivoting element comprises a roller for providing contact with said wheel suspension.

Providing the push portion of the pivoting element with a roller will imply a more gentle impact and/or pushing of that push portion onto the wheel suspension.

In one embodiment of this embodiment, the control system is being configured for receiving input from an operator; and wherein said control system, based on said input, is being configured to provide control instructions to said auxiliary actuator for control thereof.

In one embodiment of the towing device according to the present invention, the towing device further comprising one or more auxiliary wheel assemblies, such as one or two auxiliary wheel assemblies, wherein said wheel suspension, at a lower side thereof comprises one or more receiving organs for detachably mounting said auxiliary wheel assembly/assemblies; wherein said auxiliary wheel assembly comprises a wheel frame and one or more auxiliary wheels, such as one or two auxiliary wheels; wherein in respect of one or more of said auxiliary wheel assemblies, said auxiliary wheel(s) is/are mounted on its associated wheel frame so as to be able to rotate in relation to said wheel frame; wherein said wheel frame comprises a wheel frame engagement means, wherein said wheel frame engagement means is being configured to be able to detachably engage with said receiving organ of said wheel suspension.

In one embodiment of this embodiment the diameter of said auxiliary wheel(s) is/are selected from the ranges: 150-500 mm or more, such as 200-450 mm, e.g. 250-400 mm, such as 300-350 mm.

Such auxiliary wheel or wheels will enable movement of the towing device even over a rather uneven ground surface.

In one embodiment of this embodiment the receiving organ(s) of the wheel suspension and the wheel frame engagement means of the wheel frame together forms a releasable click-on coupling system, such as being in the form of a Variobloc RO 100.

In one embodiment of the towing device according to the present invention, the second set of lifting means comprises a parallelogrammical suspension, wherein a first end of said parallelogrammical suspension is being mounted at the longitudinally rear end of said support surface, and wherein a second opposite end of said parallelogrammical suspension is being mounted to said separatable propulsion cart; wherein one or more actuators are being mounted to said parallelogrammical suspension in such a way that actuation of said one or more actuators will effect a raising or lowering of said longitudinally rear end of said support surface in relation to ground level.

Hereby a sturdy second set of lifting means may be provided.

In one embodiment of the towing device according to the present invention, the wheel suspension comprises one or more wheels in the form of rollers, supporting said support frame at a longitudinal front end thereof.

Hereby adequate movement over ground of the longitudinally front end of the towing device is ensured.

In one embodiment of the towing device according to the present invention, the support surface is having an extension in its longitudinal direction X of 200-550 cm, such as 250-500 cm, such as 300-450 cm, for example 350-400 cm.

In one embodiment of the towing device according to the present invention, the support surface is having an extension in its transversal direction Y of 50-225 cm, such as 75-200 cm, for example 100-175 cm, such as 125-150 cm.

In one embodiment of the towing device according to the present invention, the support surface, in its lowest lowered position is having a maximum height level above ground level 6 of 7.5-80 cm, such as 10-75 cm, e.g. 15-70 cm, such as 20-65 cm, for example 25-60 cm, such as 30-55 cm, for example 35-50 cm or 40-45 cm.

In one embodiment of the towing device according to the present invention, the support surface, in its highest raised position is having a height level above ground level 6 of 40-85 cm, such as 45-80 cm, for example 50-75 cm, for example 55-70 cm or 60-65 cm.

These dimensions have proved advantageous for the intended purpose of towing a vehicle.

In one embodiment of the towing device according to the present invention the towing device further comprising an array of detachable wheel supports, such as an array of wheel supports sufficient for supporting four wheels of a vehicle to be towed, wherein each wheel support comprises a first attachment means and wherein said frame of said towing device, at opposite longitudinal sides thereof, comprises a second attachment means, wherein said first attachment means of said wheel support is configured to be detachable mounted to said second attachment means of said frame of said towing device.

Wheel supports allows for lifting a vehicle to be towed away without imposing any damage to the undercarriage of the vehicle.

In one embodiment of the towing device according to the present invention the second attachment means comprises an upwardly extending rail being arranged at opposite longitudinal sides of said frame, wherein said upwardly extending rail optionally comprises a longitudinally arranged array of holes for receiving a locking element, such as a locking bolt, thereby allowing locking a first attachment means of said wheel support to said second attachment means of said frame.

In one embodiment of this embodiment the wheel support comprises a rod having a first end and an opposite second end, wherein said first end comprises said first engagement means.

In one embodiment of this embodiment the first engagement means comprises a block comprising a recess, wherein the geometry and dimensions of said upwardly extending rail of said frame, on the one hand, and the geometry and dimensions of said recess of said block, on the other hand, are adapted to each other in such a way that part of said rail may be accommodated in said recess of said block.

In one embodiment of this embodiment the rail comprises an array of longitudinally arranged holes, and wherein said block of said first engagement means comprises a hole, thereby, via said holes in said rail and via said hole in said block, allowing locking of said first engagement means of said wheel support to said second engagement means of said frame, such as by use of a locking bolt.

These four embodiments provide for a simple, yet efficient way of lifting a vehicle using wheel supports.

In an alternative embodiment of the wheel support, the frame of said towing device comprises longitudinally arranged beams arranged at opposite sides thereof, and wherein said second attachment means comprises a hollow interior in each said beam at a first longitudinal end thereof.

In one embodiment of this embodiment the wheel support comprises an L-shaped element having a first end and an opposite, second end, wherein said first end of said L-shaped element is forming said first engagement means by having geometries and dimensions allowing said first end of said L-shaped element to be accommodated in the hollow interior of said longitudinally arranged beam of said frame at said first longitudinal end thereof.

In one embodiment of this embodiment the wheel support comprises a locking element for locking said first end of said L-shaped element into said hollow interior of said beam of said frame, such as in the form of a locking bolt.

In an alternative embodiment the geometry of the L-shaped element is not L-shaped but rather linearly shaped with a first end and an opposite, second end, wherein the first end of this linearly shaped element is forming said first engagement means by having geometries and dimensions allowing the first end of said linearly shaped element to be accommodated in the hollow interior of said longitudinally arranged beam of said frame at said first longitudinal end thereof.

In a preferred embodiment of this embodiment the linearly shaped element comprises attachment means for detachably mounting two wheel supports at the portion of the linearly element which is not being inserted into the longitudinally arranged beam of said frame.

In a preferred embodiment, such attachment means comprises first attachment means arranged at the two wheel supports and comprises second attachment means arranged on/at the linearly shaped element.

These three embodiments also provide for a simple, yet efficient way of lifting a vehicle using wheel supports.

It is preferred to use six support elements of the first type and two support of the second type.

### The Second Aspect of the Present Invention

In a second aspect the present invention relates to a use of a towing device according to the first aspect of the invention for moving a vehicle from a first location to a second location.

In one embodiment of the use of the towing device according to the present invention, the vehicle is a vehicle which has caught fire.

### The Third Aspect of the Present Invention

In a third aspect the present invention relates to a method for moving a vehicle from one location to another location; said method comprises the steps of:
i) providing a towing device according to the first aspect of the present invention;
ii) arranging the towing device in line with the longitudinal direction of the vehicle to be moved, either in front of or behind that vehicle;
iii) ensuring that the support surface is being arranged in a lowered configuration;
iv) using said control system of said towing device to propel and steer said device in order to arrange said support surface, or at least part thereof, of the device below said vehicle to be moved;
v) once arranged below said vehicle to be moved, via said control system, raising said support surface a predetermined distance by means of said lifting means;
vi) using said control system of said towing device to propel and steer said towing device in order to move said vehicle from a first location to a second location.

In one embodiment of the method according to the third aspect of the invention, the method further comprises, subsequent to step iv), the step of:
iva) in respect of each wheel of said vehicle to be towed, arranging a wheel support in front of said wheel and arranging a wheel support behind said wheel by making said first engagement means of each said wheel support enter into engagement with said second engagement means of said frame; and optionally also locking said wheel support to said frame 2; wherein said wheel support is as defined in the sections above.

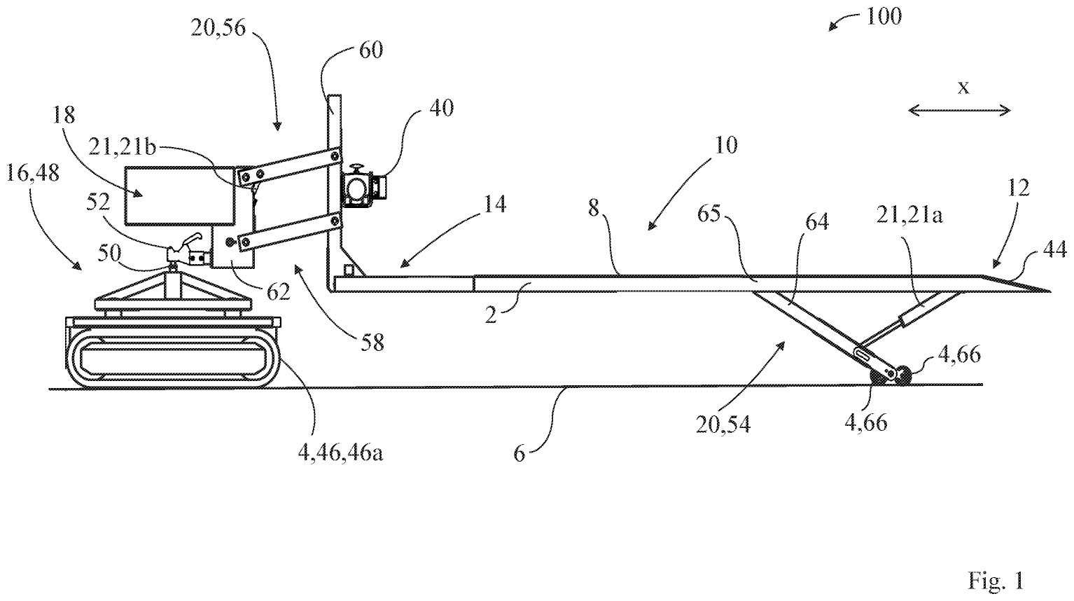

Referring now to the figures, in order to better illustrate the present invention, FIG. 1 is a side view illustrating the towing device according to the first aspect of the present invention with its support surface in its raised configuration.

FIG. 1 shows the towing device 100. The towing device 100 is for moving a vehicle from a first location to a second location. The towing device 100, in the orientation intended during use, comprises a frame 2 with sets of wheels 4 which are supported on a ground surface 6.

The frame 2 comprises a support surface 8 at an upper portion 10 thereof. The support surface 8 is having an extension in a longitudinal direction X and in a transversal direction Y (not seen in FIG. 1), which is perpendicular to said longitudinal direction.

The support surface 8 is having a longitudinal front end 12 and a longitudinal rear end 14.

The towing device 100 also comprises propulsion means 16 for propelling the device. The propulsion means 16 is in form of a separatable propulsion cart 48 which via a first coupling means 50 is detachable being coupled to a second coupling means 52 which in turn is mechanically connected to the frame 2. The coupling means 50,52 are in the form of a standard coupling means or hiss for attaching a trailer to a passenger car.

The separatable propulsion cart 48 of the towing device illustrated in FIG. 1 comprises drive means 46,46a, 46b in the form a first set 46a of or drive caterpillars arranged at a right side of the towing device and a second set 46b of drive caterpillars arranged at a left side of the towing device (nit seen in FIG. 1).

The towing device 100 comprises lifting means 20 for raising and lowering said support surface 8 in relation to said ground surface 6.

The lifting means 20 comprises a first set of lifting means 54 which is configured for lifting/lowing the longitudinal front end 12 of said support surface 8 and a second set of lifting means 56 which is configured for lifting/lowing the longitudinal rear end 14 of said support surface 8.

It is seen in FIG. 1 that the first set of lifting means 54 comprises a wheel suspension 64 which is being pivotally mounted to the frame 2 and that an actuator 21,21a is being mounted between the wheel suspension 64 and said frame 2 in such a way that actuation of the actuator 21,21a will effect a pivoting of said wheel suspension 64 around a pivot axis 65, which is being perpendicular to the longitudinal direction of said support surface 8.

It is also seen in FIG. 1 that the second lifting means 56 comprises a parallelogrammical suspension 58, wherein a first end 60 of that parallelogrammical suspension 58 is being mounted at the longitudinally rear end 14 of the support surface 8, and that a second opposite end 62 of the parallelogrammical suspension 58 is being mounted to the separatable propulsion cart 48. It is also seen that an actuator 21,21b is being mounted to the parallelogrammical suspension 58 in such a way that actuation of the actuator 21,21b will effect a raising or lowering of said longitudinally rear end 14 of the support surface 8, in relation to ground level.

The wheel suspension 64 comprises a plurality of wheels 4 in the form of rollers 66, supporting the support frame 2 at the longitudinal front end 12 thereof.

Accordingly, the first set lifting means 54 and the second set of lifting means 56 collectively will provide for raising and lowering the support surface 8 in relation to the ground surface 6.

A control system 18 is provided for controlling the operation of said towing device, i.e. controlling the movement of the propulsion cart 48 as well as controlling the lifting means 20 comprising the first set lifting means 54 and the second set of lifting means 56.

As already mentioned, FIG. 1 shows the towing device with its support surface 8 in its raised configuration.

It is preferred that in its raised position, the upper surface of the support surface 8 is having a highest height level above ground level 6 of 40-85 cm, such as 45-80 cm, for example 50-75 cm, for example 55-70 cm or 60-65 cm.

The towing device comprises an electrically motorised winch 40, including a wire for attachment to the vehicle to be moved. Hereby the vehicle to be moved can be secured on top of the support surface 8 of the towing device 100, and moreover the winch 40 will aid in bringing that vehicle on top of the support surface 8.

FIG. 1 also shows that the support surface 8 of the towing device 100, at a longitudinal front end 12, comprises an inclined platform part 44, which in a predetermined distance, is inclined downward, in a forward, longitudinal direction, compared to the inclination of the rest of the support surface 8.

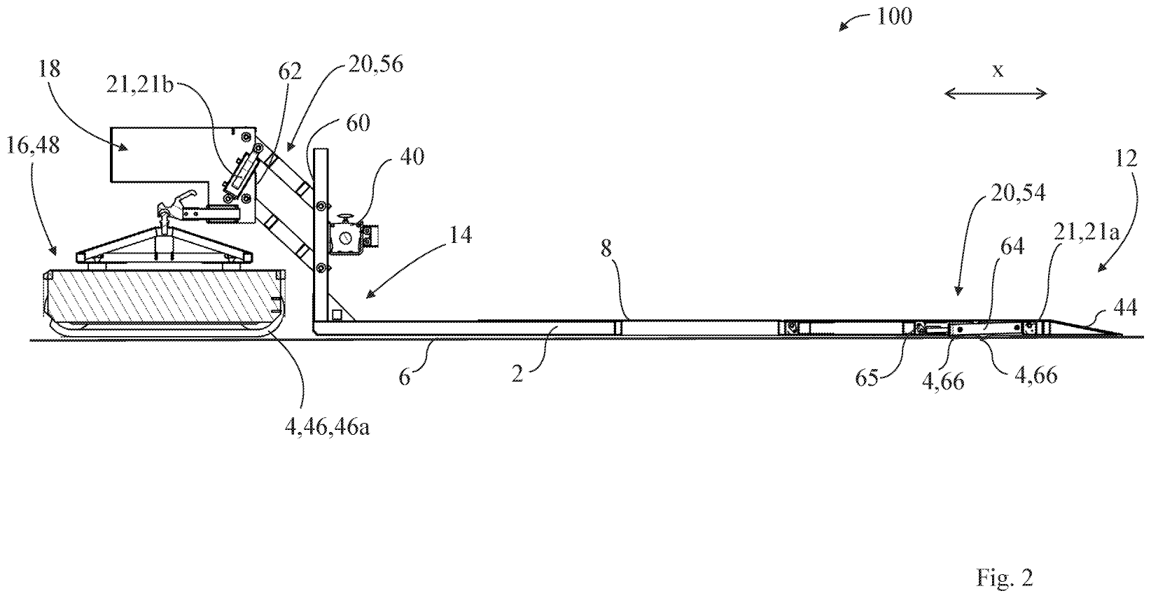

FIG. 2 is a side view illustrating the towing device according to the first aspect of the present invention with its support surface in its lowered configuration.

FIG. 2 shows the towing device 100 of FIG. 1. It is easily comprehended that in going from the situation in FIG. 1 to the situation in FIG. 2 the actuator 21,21a of the first set lifting means 54 and the actuator 21,21b of the second set of lifting means 56 of the lifting means have been actuated so as to lower the support surface 8 of the frame.

It is preferred that in its lowered position, the upper surface of the support surface 8 is having a maximum height level above ground level 6 of 7.5-80 cm, such as 10-75 cm, e.g. 15-70 cm, such as 20-65 cm, for example 25-60 cm, such as 30-55 cm, for example 35-50 cm or 40-45 cm.

Such small heights above ground 6 ensures that the frame 2 of the towing device 100 can be arranged underneath most vehicles prior to moving thereof.

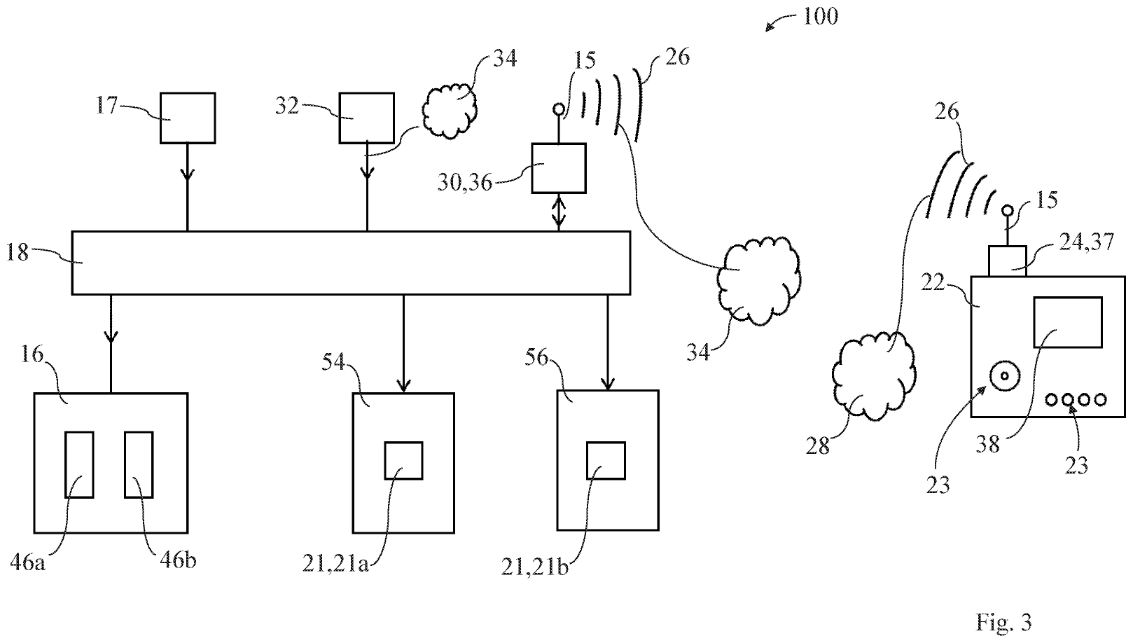

FIG. 3 is a schematic diagram illustrating the working mode of controlling the towing device according to the invention.

FIG. 3 schematically illustrates the towing device 100 comprising a control system. An energy storage 17 in the form of a battery is connected to the control system 18. The control system 18 is configured, upon being provided with control instructions thereto, to provide electrical power to the propulsion means 16 comprises drive means 46,46a and 46,46b.

Likewise, the control system 18 is configured, upon being provided with control instructions thereto, to control the first set of lifting means 54 comprising actuators 21,21a, and to control the second set of lifting means 56 comprising actuators 21,21b.

In order to provide control instructions to the control system 18, a remote control 22 is used. The remote control 22 comprises input means 23 for inputting instructions by a human operator.

The remote control 22 is provided with a transmitter 24 for transmitting electromagnetic radiation 26 representing control instructions. The control instructions are in FIG. 3 illustrated by the blurry blob 28. The control system 18 comprises a receiver 30 for receiving that electromagnetic radiation 26 representing the control instructions 28. The electromagnetic radiation is conveyed via antennas 15.

Also seen in FIG. 3 is that the towing device 100 comprises an image capturing unit 32 which is configured to capture images and convey information relating to this image to the control system 18. In FIG. 3 the information relating to the image is represented by the blurry blob 34.

The towing device 100 comprises a transmitter 36 for transmitting electromagnetic radiation 26 representing the images 34 captured by the image capturing unit 32. Moreover, the remote control 22 comprises a receiver 37 which is configured to receive the electromagnetic radiation 26 representing the images 34. Finally, the remote control 22 comprises a display 38 for displaying the images 34 represented by said electromagnetic radiation 26 and captured by that image capturing unit 32.

Hereby an operator may operate the towing vehicle even under conditions of poor light and/or in a smoky environment.

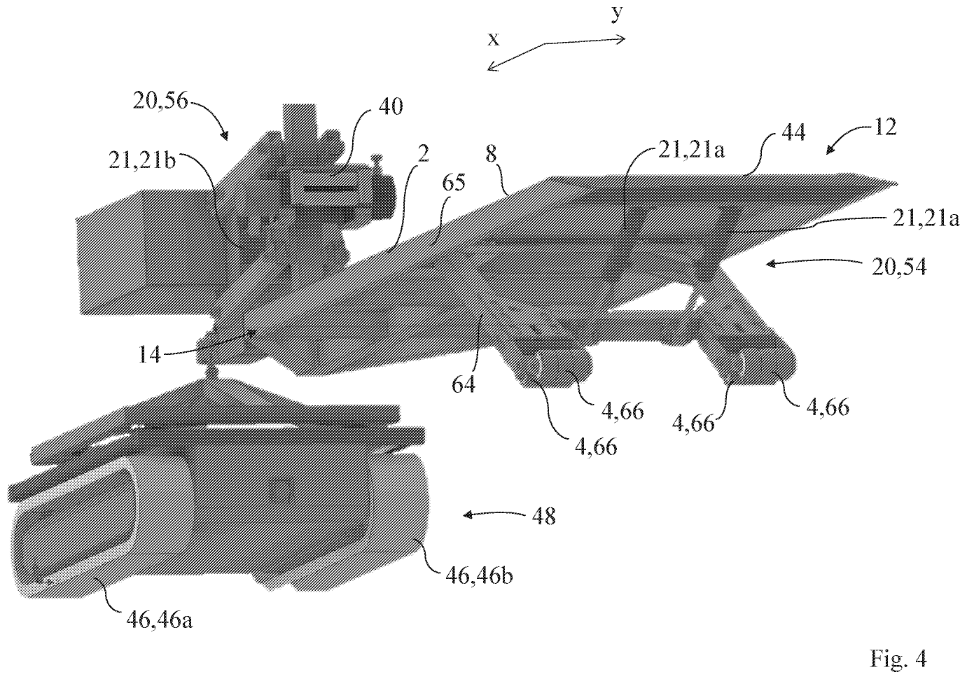

FIG. 4 is a perspective view of the towing device of FIGS. 1 and 2 illustrating details of the first set of lifting means.

It is seen in FIG. 4 that the first set of lifting means 54 comprises the wheel suspension 64 which is being pivotally mounted to the frame 2 and that two actuators 21,21a are being mounted between the wheel suspension 64 and the frame 2 in such a way that actuation of the actuators 21,21a will effect a pivoting of said wheel suspension 64 around the pivot axis 65.

The wheel suspension 64 comprises four sets of wheels 4 in the form of rollers 66, supporting the support frame 2 at the longitudinal front end 12 thereof.

Also seen in FIG. 4 is that the propulsion cart 48 comprises a first set 46a of drive caterpillars arranged at a right side of the towing device and a second set 46b of drive caterpillars arranged at a left side of the towing device.

In this design, the towing device is configured for being steered by effecting a higher or lower rotation of the first set 46a of drive caterpillars relative to the second set 46b of drive caterpillars, whereas an identical magnitude of rotation of the two sets 46a,46b of drive caterpillars will effect a forward directing or backward directing movement of the towing device.

The design of the towing device illustrated in FIGS. 1, 2 and 4 is particularly well-suited for towing a vehicle without much concern about keeping the undercarriage of the vehicle intact. Such a situation is present in a case where the vehicle is on fire.

However, it may be advantageous to be able to tow away a vehicle without imposing any destructive impact to the vehicle.

To this end the first aspect of the present invention provides further measures.

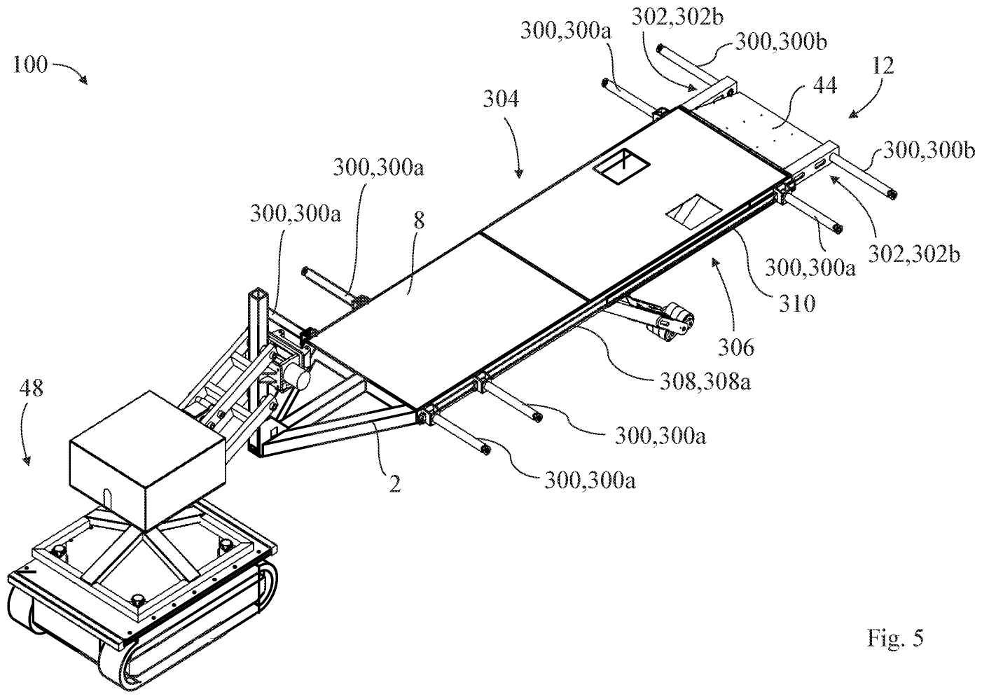

This is illustrated in FIGS. 5-8.

FIG. 5 is a perspective view of the towing device according to the first aspect of the present invention in which the towing device has been provided with wheel supports.

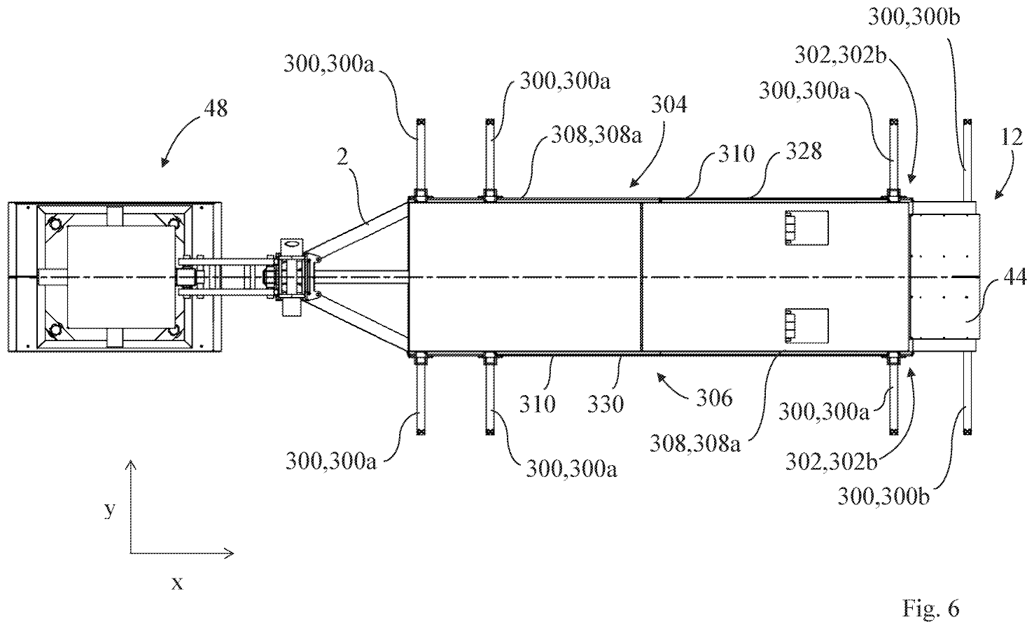

FIG. 6 is a top view of the embodiment illustrated in FIG. 5.

FIGS. 5 and 6 show the towing device 100 comprising a propulsion cart 48 coupled to a frame 2. The frame 2 at opposite longitudinal sides 304,306 thereof carries eight wheel supports 300,300a,300b which pairwise are configured to carry a single wheel of a vehicle.

It is seen that six wheel supports 300,300a in the shape of a rod are detachable attached to a rail 310 at each longitudinal side 304,306 of the frame 2 of the towing device.

It is also seen in FIGS. 5 and 6 that two L-shaped wheel supports 300,300b are attached to the frame 2 at the first longitudinal end 12 thereof.

Each wheel support comprises a first engagement means 302,302a,302b which is configured to enter into engagement with a second engagement means 308,308a,308b of the frame 2, as explained further below.

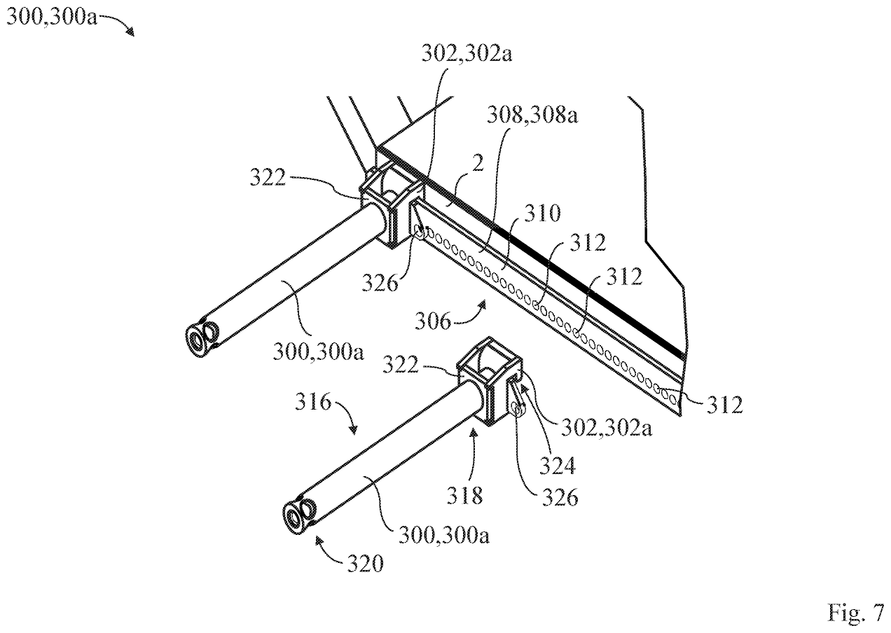

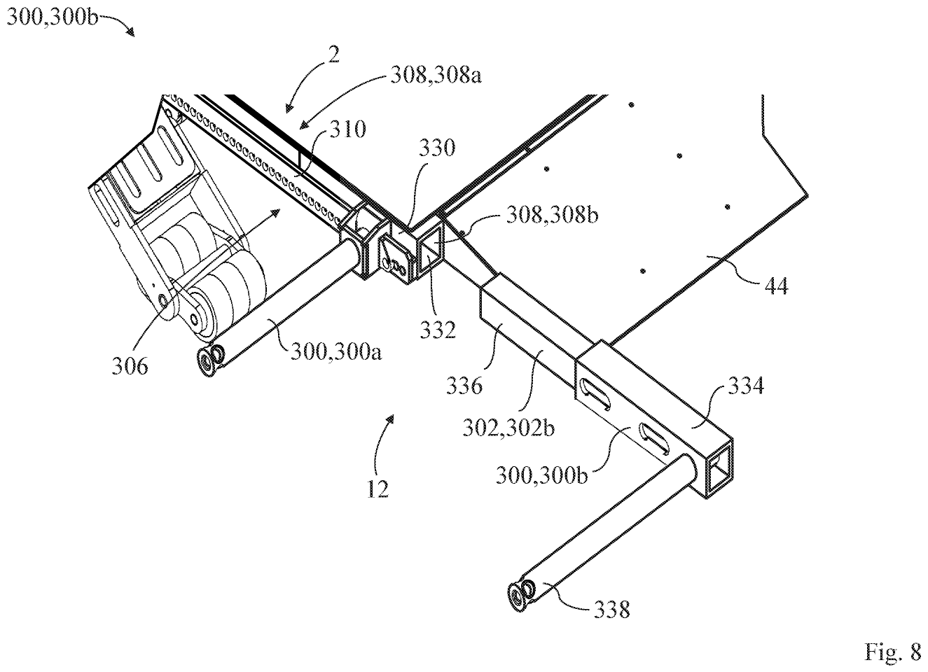

The details relating to the eight wheel supports are disclosed with reference to FIGS. 7 and 8.

FIG. 7 is a perspective view illustrating details of a first kind of wheel support to be attached to the frame of the towing device.

FIG. 7 shows the wheel support 300,300a comprising a rod 316 having a first end 318 and an opposite second end 320. The first end comprises first engagement means 302,302a.

Also seen in FIG. 7 is that the frame 2 carries second attachment means 308,308a. The second attachment means 308,308a comprises an upwardly extending rail 310 which is being arranged at a longitudinal side 306 of the frame 2.

FIG. 7 shows that the first engagement means 302,302a comprises a block 322 comprising a recess 324. The geometry and dimensions of the upwardly extending rail 310 of the frame 2, on the one hand, and the geometry and dimensions of the recess 324 of the block 322, on the other hand, are adapted to each other in such a way that part of said rail 310 may be accommodated in said recess 324 of said block 322 as seen.

The upwardly extending rail 310 comprises a longitudinally arranged array of holes 312 for receiving a locking element 314.

It is also seen that the block 322 of the first engagement means 302,302a comprises a hole 326.

Hereby, the first engagement means 302,302a of the wheel support 300,300a can be locked to the second engagement means 308,308a of the frame 2, such as by use of a locking bolt 314 which penetrates the hole 326 in the block 322 and one of the holes 312 in the frame 2.

FIG. 8 is a perspective view illustrating details of a second kind of wheel support to be attached to the frame of the towing device.

FIG. 8 shows that the frame 2 of the towing device comprises a longitudinally arranged beam 330 arranged at side 306 thereof. The second attachment means 308,308b comprises a hollow interior 332 in each said beam 330 at a first longitudinal end 12 thereof.

FIG. 8 also shows that the wheel support 300,300b comprises an L-shaped element 334 having a first end 336 and an opposite, second end 338, wherein said first end 336 of said L-shaped element 334 is forming said first engagement means 302,302b by having geometries and dimensions allowing the first end 336 of the L-shaped element 334 to be accommodated in the hollow interior 332 of said longitudinally arranged beam 328,330 of said frame 2 at said first longitudinal end 12 thereof.

In an alternative embodiment the element 334 is not L-shaped but rather linearly shaped with a first end 336 and an opposite, second end 338. The first end 336 of this linearly shaped element 334 is forming said first engagement means 302,302b by having geometries and dimensions allowing the first end 336 of the element 334 to be accommodated in the hollow interior 332 of said longitudinally arranged beam 328,330 of said frame 2 at said first longitudinal end 12 thereof. This embodiment is not shown in the figures.

Furthermore, in this embodiment the linearly shaped element 334 comprises attachment means for detachably mounting two wheel supports 300,300a at the portion of the element 334 which is not being inserted into the longitudinally arranged beam 328,330 of said frame 2. Such attachment means are preferably as described above with reference to FIG. 7, that is in the form of providing the two wheel supports 300,300a with first attachment means 302,302a, and by providing the linearly shaped element 334 with second attachment means 308,308a.

Accordingly, such attachment means mimics the principle illustrated in FIG. 7.

A locking element 314 (not shown in FIG. 8) may be used for locking the first end 336 of the L-shaped element 334 into said hollow interior 332 of said beam 328,330 of said frame 2, such as in the form of a locking bolt.

It appears that in case of a vehicle having four wheels, eight wheel supports 300,300a,300b are needed.

It is preferred to use six support elements 300,300a having a design as illustrated in FIG. 7 and two support elements 300,300b having a design as illustrated in FIG. 8.

During use of the embodiment illustrated in FIGS. 5-8, the following procedure may be followed:
i) providing a towing device 100 according to the first aspect of the present invention;
ii) arranging the towing device 100 in line with the longitudinal direction of the vehicle 200 to be moved, either in front of or behind that vehicle;
iii) ensuring that the support surface 8 is being arranged in a lowered configuration;
iv) using said control system 18 of said towing device to propel and steer said device in order to arrange said support surface 8, or at least part thereof, of the towing device, below said vehicle 200 to be moved;
iva) in respect of each wheel of said vehicle to be towed, arranging a wheel support 300,300a,300b in front of said wheel and arranging a wheel support 300,300a,300b behind said wheel by making said first engagement means 302,302a,302b of each said wheel support enter into engagement with said second engagement means 308,308a,308b of said frame 2; and optionally also locking said wheel support 300,300a,300b to said frame 2; wherein said wheel support 300,300a,300b is as defined above;
v) once arranged below said vehicle 200 to be moved, via said control system 18, raising said support surface 8 a predetermined distance by means of said lifting means 20;
vi) using said control system 18 of said towing device 100 to propel and steer said towing device in order to move said vehicle 200 from said first location to said second location.

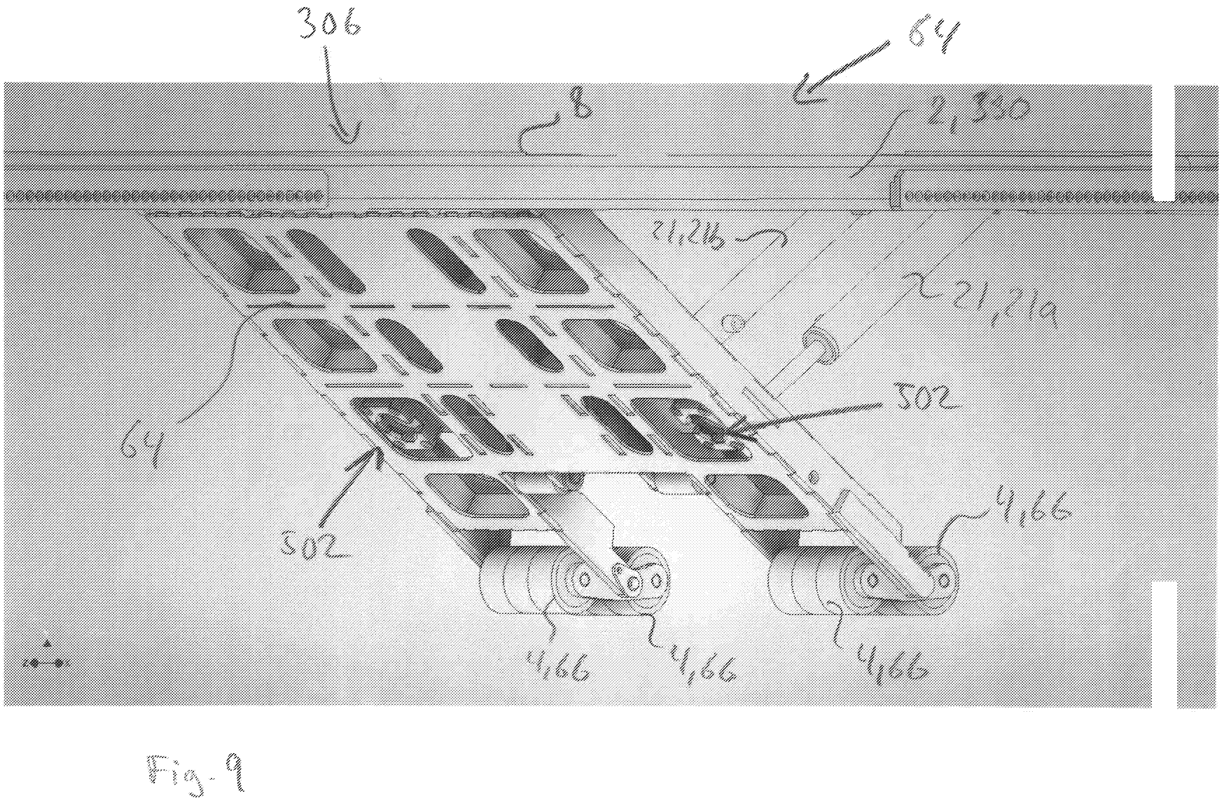

FIG. 9 is a perspective view illustrating the presence and position of two receiving organs for auxiliary wheel assemblies at a lower part of the wheel suspension of the frame of the towing device.

FIG. 9 shows the frame 2 with its support surface 8. From the level of the support surface a wheel suspension 64 extends downwardly. Roller wheels 4,66 are provided to support the wheel suspension 64 on a ground surface.

A lower side of the wheel suspension 64 comprises two receiving organs 502 for mounting auxiliary wheel assemblies.

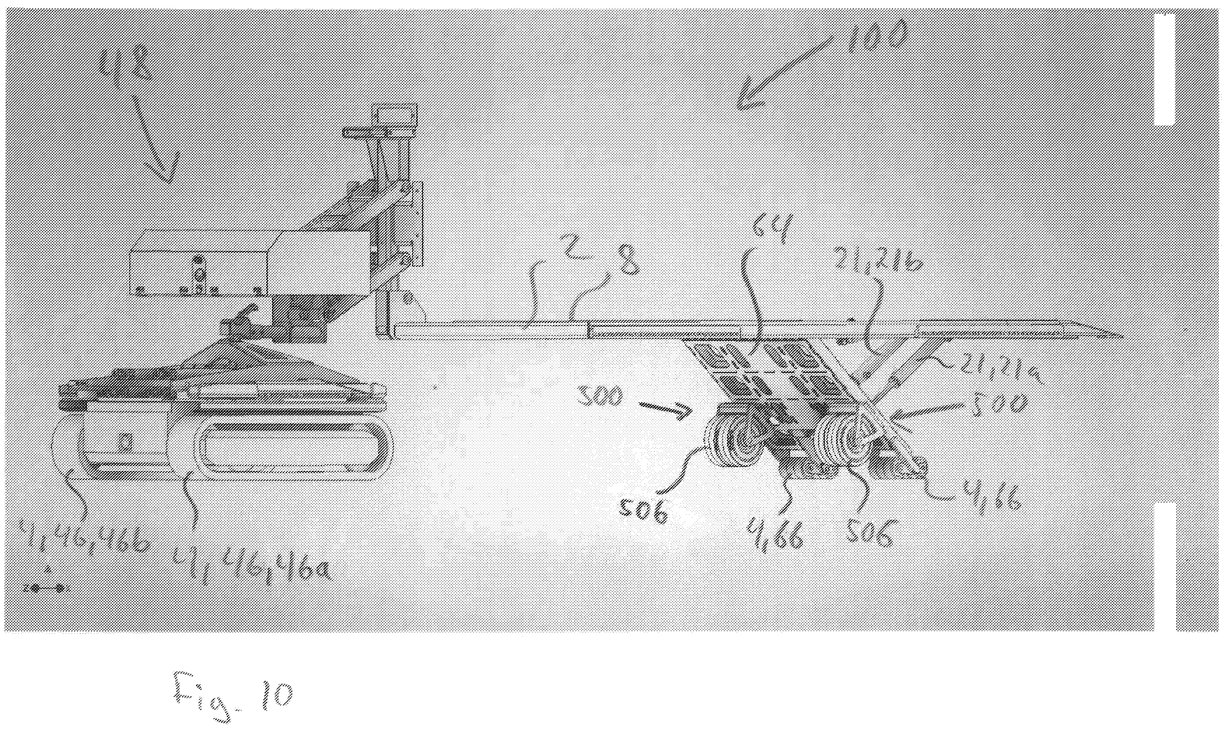

This is seen in FIG. 10.

FIG. 10 is a perspective view illustrating a towing device with its wheel suspension provided with two auxiliary wheel assemblies at a lower part thereof.

FIG. 10 shows the towing device 100 with its wheel suspension 64, wherein an auxiliary wheel assembly 506 has been mounted in each of the two receiving organs 502 seen in FIG. 9.

This allows moving of a vehicle over a fairly large distance even in case the ground surface in very uneven.

In doing this, the actuators 21,21a,21b seen in FIG. 10 are first actuated so as to raise the wheel suspension 64 which in turn makes the auxiliary wheels 506 touch the ground surface instead of having the roller wheels 4,66 touch the ground surface. Subsequently the towing device can be moved over an uneven ground surface.

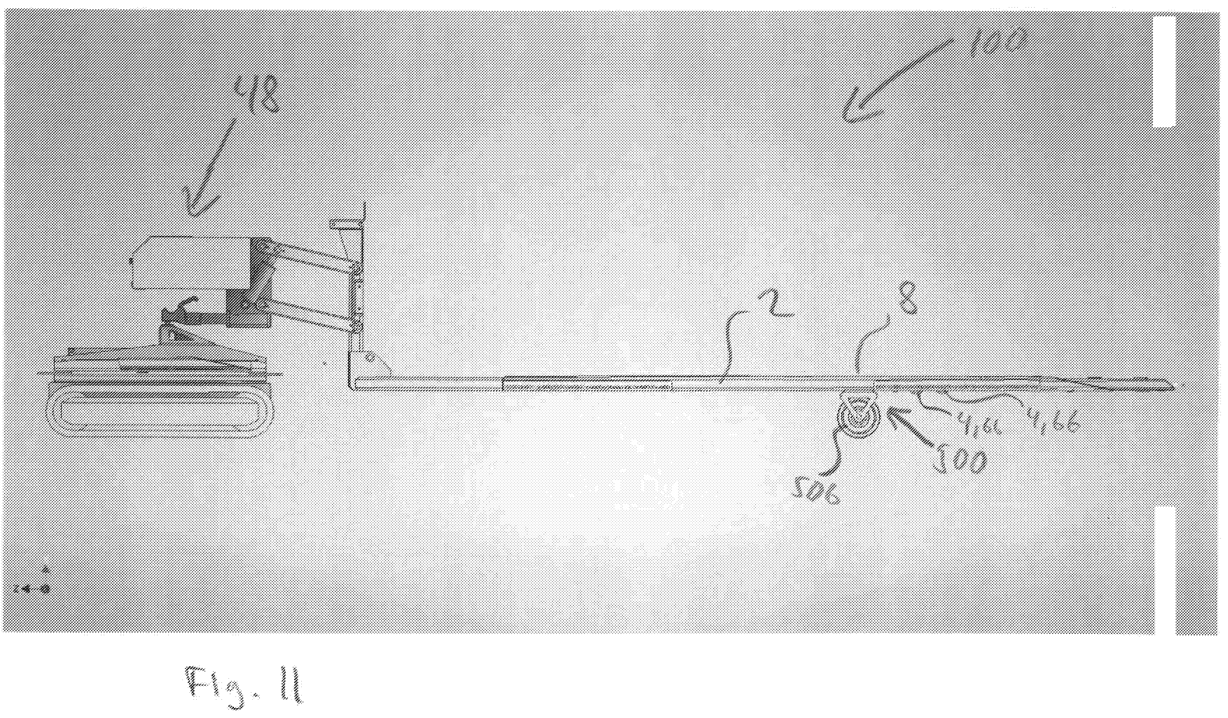

FIG. 11 shows in a side view the towing device 100 in this situation in which the wheel suspension 64 has been raised so that auxiliary wheels 506 touch the ground surface.

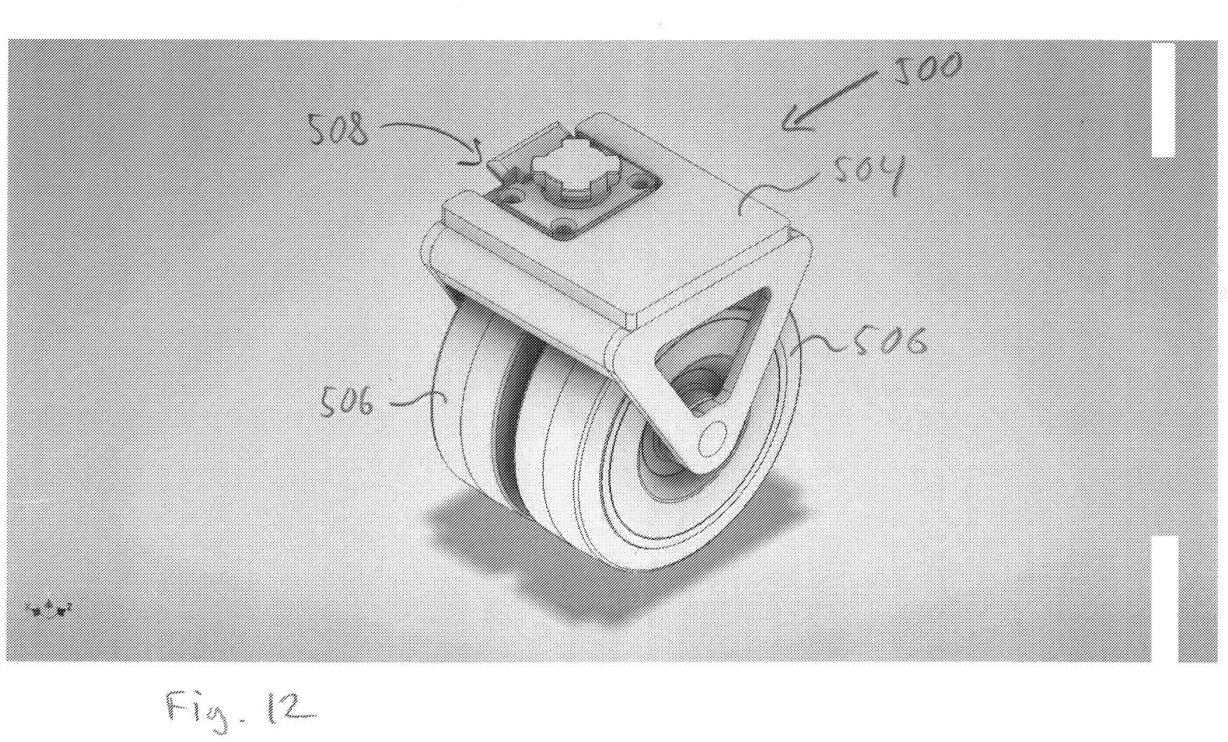

FIG. 12 is a perspective view illustrating an auxiliary wheel assembly to be mounted onto the wheel suspension of the frame of the towing device.

FIG. 12 shows auxiliary wheel assembly 500 comprising a wheel frame 504 and two auxiliary wheels 506. The auxiliary wheels 506 are mounted on the wheel frame 504 so as to be able to rotate in relation to said wheel frame upon exerting a torque thereto.

It is seen that the wheel frame 504 comprises a wheel frame engagement means 508.

The wheel frame engagement means 508 is being configured to be able to detachably engage with the receiving organ 502 of the wheel suspension 64 illustrated in FIG. 9 so as to arrive at the situation illustrated in FIGS. 10 and 11.

The receiving organs 502 of the wheel suspension 64 and the wheel frame engagement means 508 of the wheel frame 504 together forms a click-on coupling system.

The commercially available system Variobloc RO 100 has been found excellent for use as the wheel frame engagement means 508 and the receiving organ 502 of the wheel suspension 64, respectively.

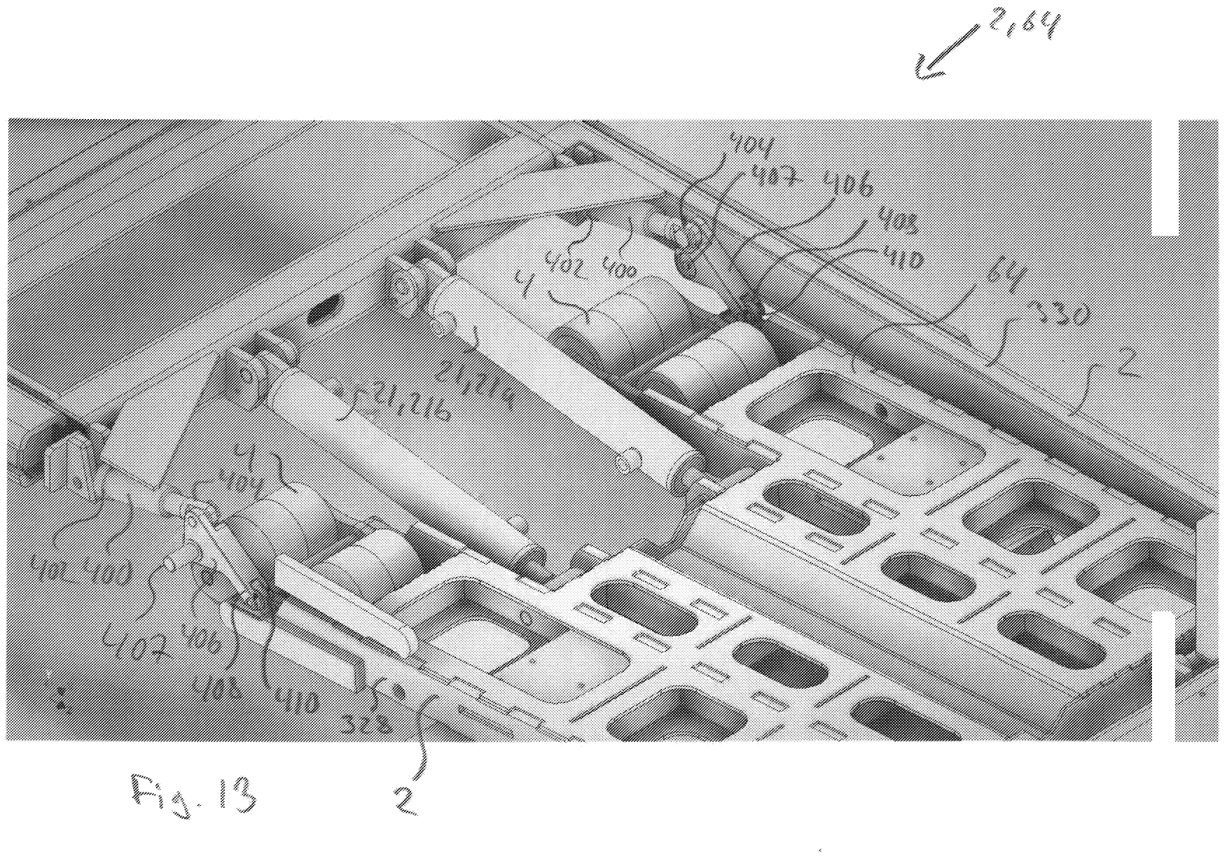

FIG. 13 is a perspective view illustrating the presence and position of two auxiliary actuators with their associated respective pivoting elements at the wheel suspension of the frame of the towing device in their expanded configuration.

FIG. 13 shows part of the frame 2 of the towing device 100 with two longitudinally arranged beams 328,330.

The two longitudinally arranged beams 328,330 comprises a pivoting element 406 which has been mounted onto an inner side thereof so as to be able to pivot around a pivoting axis 407. The pivoting element 406 comprises a push portion 408.

An auxiliary hydraulic actuator 400 having a first end 402 and a second end 404 is being arranged at each of the two longitudinally arranged beams 328,330.

The first end 402 of the auxiliary actuator 400 is being pivotally fastened to the frame 2 and the second end 404 of the auxiliary actuator 400 is being pivotally fastened to said pivotally element 406.

Each of the auxiliary actuators is able to change its configuration between a compressed configuration and an expanded configuration and vice versa, by actuation thereof.

In FIG. 13 the auxiliary actuators 400 are being in their expanded configuration. The actuation of the auxiliary actuators 400 into their expanded configuration has caused the push portion 408 of the pivoting element 406 to push onto the wheel suspension 64 in a downward direction.

In this way the auxiliary actuators 400 will aid the actuator 21,21a,21b in its initial movement upon lifting the support surface 8 of the frame 2 in relation to the ground surface 6.

This effect is caused by the fact that when the auxiliary actuators 400 are into their expanded configuration so that the wheel suspension 64 is being pivoted in a downward direction an increased height difference between the two opposite ends of the actuators 21,21a,21b will be attained and this increased height difference will make the actuators 21,21a,21b more efficient when their expansion are to cause the wheel suspension 64 to be pivoted in a downward direction.

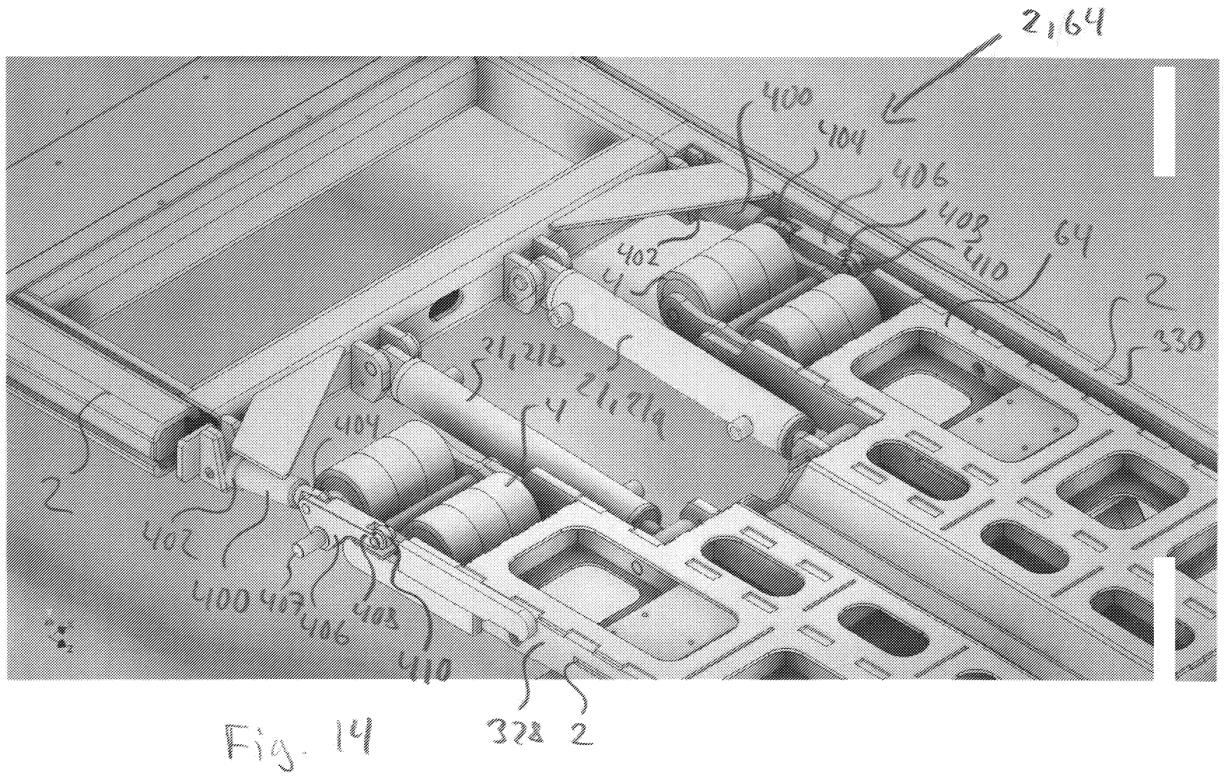

FIG. 14 is a perspective view illustrating the presence and position of two auxiliary actuators with their associated respective pivoting elements at the wheel suspension of the frame of the towing device in their compressed configuration.

FIG. 14 shows that in this situation the height difference between the two opposite ends of the actuators 21,21a,21b are considerably smaller, compared to the situation illustrated in FIG. 13, hence making it more difficult, in the absence of the auxiliary actuators 400, to effect the pivoting movement of the wheel suspension 64 in a downward direction.

It should be understood that all features and achievements discussed above and in the appended claims in relation to one aspect of the present invention and embodiments thereof apply equally well to the other aspects of the present invention and embodiments thereof.

### LIST OF REFERENCE NUMERALS

2 Frame of towing device
4 Wheel of towing device
6 Ground surface
8 Support surface of towing device
10 Upper portion of frame of towing device
12 Longitudinal front end of support surface of towing device
14 Longitudinal rear end of support surface of towing device
15 Antenna
16 Propulsion means of towing device
17 Energy storage
18 Control system of towing device
20 Lifting means of towing device
21,21a,21b Actuator
22 Remote control for controlling said towing device
23 Input means of remote control for inputting control instructions
24 Transmitter of remote control for transmitting electromagnetic radiation
26 Electromagnetic radiation
28 Control instruction
30 Receiver of control system for receiving electromagnetic radiation
32 Image capturing unit
34 Image
36 Transmitter of control system for transmitting electromagnetic radiation
37 Receiver of remote control for receiving electromagnetic radiation
38 Display
40 Winch
42 Wire of winch
44 Inclined platform part at a longitudinal front end
46,46a,46b Drive means
48 Propulsion cart
50 First set coupling means of hiss
52 Second of coupling means of hiss
54 First set of lifting means
56 Second set of lifting means
58 Parallelogrammical suspension
60 First end of parallelogrammical suspension
62 Second, opposite end of parallelogrammical suspension
64 Wheel suspension
65 Pivot axis
66 Roller wheel
100 Towing device according to the invention
300,300a,300b Detachable wheel support
302,302a,302b First attachment means
304,306 Opposite longitudinal sides of frame of towing device
308,308a,308b Second attachment means
310 Upwardly extending rail
312 Hole in rail
314 Locking element
316 Rod of wheel support
318 First end of rod
320 Second end of rod
322 Block of first engagement means
324 Recess of block
326 Hole in block of first engagement means
328,330 Longitudinally arranged beam of frame
332 Hollow interior of longitudinally arranged beam of frame
334 L-shaped element of wheel support
336 First end of L-shaped element
338 Second end of L-shaped element
400 Auxiliary actuator
402 First end of auxiliary actuator
404 Second end of auxiliary actuator
406 Pivoting element
407 Pivoting point of pivoting element
408 Push portion of pivoting element
410 Roller of push portion of pivoting element
500 Auxiliary wheel assembly
502 Receiving organ for auxiliary wheel assembly
504 Wheel frame of wheel assembly
506 Auxiliary wheel of auxiliary wheel assembly
508 Wheel frame engagement means

1. A towing device for moving a vehicle from a first location to a second location;
wherein said towing device, in the orientation intended during use, comprises a frame, wherein said frame comprises one or more sets of wheels to be supported on a ground surface;
wherein said frame comprises a support surface at an upper portion thereof, wherein said support surface is having an extension in a longitudinal direction and in a transversal direction, which is perpendicular to said longitudinal direction;
wherein said support surface is having a longitudinal front end and a longitudinal rear end, wherein said support surface is being configured to be arranged below a vehicle and support said vehicle to be moved;
wherein said towing device comprises propulsion means for propelling said towing device;
wherein said towing device comprises a control system for controlling the operation of said towing device;
wherein said towing device comprises lifting means for raising and lowering said support surface in relation to said ground surface;
characterized in that said towing device comprises drive means in the form of a first set of drive wheels or drive caterpillars arranged at a right side of the towing device and a second set of drive wheels or drive caterpillars arranged at a left side of the towing device;
characterized in that said lifting means comprises a first set of lifting means which is configured for lifting/lowing the longitudinal front end of said support surface; and
wherein said lifting means comprises a second set of lifting means which is configured for lifting/lowing the longitudinal rear end of said support surface;
and in that said first set of lifting means comprises a wheel suspension which is being pivotally mounted to said frame and wherein one or more actuators are being mounted between said wheel suspension and said frame in such a way that actuation of said one or more actuators will effect a pivoting of said wheel suspension around a pivot axis.

2. (canceled)

3. A towing device according to claim 1, wherein said towing device comprises a remote control comprising a transmitter for transmitting electromagnetic radiation representing control instructions, and wherein said control system comprises a receiver for receiving electromagnetic radiation representing said control instructions.

4. A towing device according to claim 3, wherein said towing device comprises one or more image capturing units which is/are each configured to capture images and wherein said towing device comprises a transmitter for transmitting electromagnetic radiation representing said images; wherein said remote control comprises a receiver configured to receive said electromagnetic radiation representing said images, and wherein said remote control comprises a display which is being configured to display one or more of the images represented by said electromagnetic radiation.

5. (canceled)

6. A towing device according to claim 1 wherein said lifting means comprises one or more actuators, such as electric, mechanical or hydraulic actuators, which via said control system are configured to be able to change configuration between an expanded configuration and a collapsed configuration, and thereby effect raising or lowering of said support surface in relation to said ground surface.

7. A towing device according to claim 1 wherein the towing device comprises a winch, such as a motorised winch, including a wire for attachment to the vehicle to be moved and thereby securing that vehicle on top of the support surface of the towing device and/or for aiding in bringing that vehicle on top of said support surface.

8. (canceled)

9. (canceled)

10. A towing device according to claim 1, wherein said propulsion means is being integrated with said frame, or wherein said propulsion means is in the form of a propulsion cart which is being separatable from said frame; optionally wherein said propulsion cart comprises a first coupling means and wherein said frame comprises a second coupling means; wherein said first coupling means and said second coupling means are being configured to be able to enter into releasable engagement with each other.

11. (canceled)

12. (canceled)

13. A towing device according to claim 10, wherein said first coupling means comprising the male part of a standard coupling means or hiss for attaching a trailer to a passenger car; and wherein said second coupling means comprising the female part of a standard coupling means or hiss for attaching a trailer to a passenger car.

14. (canceled)

15. (canceled)

16. A towing device according to claim 10, wherein said set of second set of lifting means comprises a parallelogrammical suspension, wherein a first end of said parallelogrammical suspension is being mounted at the longitudinally rear end of said support surface, and wherein a second opposite end of said parallelogrammical suspension is being mounted to said separatable propulsion cart; wherein one or more actuators are being mounted on said parallelogrammical suspension, in such a way that actuation of said one or more actuators will effect a raising or lowering of said longitudinally rear end of said support surface.

17. A towing device according to claim 16, wherein said wheel suspension comprises one or more wheels in the form of rollers, supporting said support frame at a longitudinal front end thereof.

18. (canceled)

19. (canceled)

20. (canceled)

21. (canceled)

22. A towing device according to claim 1 further comprising an array of detachable wheel supports, such as an array of wheel supports sufficient for supporting four wheels of a vehicle to be towed, wherein each wheel support comprises a first attachment means and wherein said frame of said towing device, at opposite longitudinal sides thereof, comprises a second attachment means, wherein said first attachment means of said wheel support is configured to be detachable mounted to said second attachment means of said frame of said towing device; optionally wherein said second attachment means comprises an upwardly extending rail being arranged at opposite longitudinal sides of said frame, wherein said upwardly extending rail optionally comprises a longitudinally arranged array of holes for receiving a locking element, such as a locking bolt, thereby allowing locking a first attachment means of said wheel support to said second attachment means of said frame.

23. (canceled)

24. A towing device according to claim 22, wherein said wheel support comprises a rod having a first end and an opposite second end, wherein said first end comprises said first engagement means.

25. A towing device according to claim 24, wherein said first engagement means comprises a block comprising a recess, wherein the geometry and dimensions of said upwardly extending rail of said frame, on the one hand, and the geometry and dimensions of said recess of said block, on the other hand, are adapted to each other in such a way that part of said rail may be accommodated in said recess of said block.

26. A towing device according to claim 24, wherein said rail comprises an array of longitudinally arranged holes, and wherein said block of said first engagement means comprises a hole, thereby via said holes in said rail and via said hole in said block, allowing locking of said first engagement means of said wheel support to said second engagement means of said frame, such as by use of a locking bolt.

27. A towing device according to claim 22, wherein said frame of said towing device comprises longitudinally arranged beams arranged at opposite sides thereof, and wherein said second attachment means comprises a hollow interior in each said beam at a first longitudinal end thereof; optionally wherein said wheel support comprises an L-shaped element having a first end and an opposite, second end, wherein said first end of said L-shaped element is forming said first engagement means by having geometries and dimensions allowing said first end of said L-shaped element to be accommodated in the hollow interior of said longitudinally arranged beam of said frame at said first longitudinal end thereof.

28. (canceled)

29. A towing device according to claim 27, wherein said wheel support comprises a locking element for locking said first end of said L-shaped element into said hollow interior of said beam of said frame, such as in the form of a locking bolt.

30. (canceled)

31. A towing device according to claim 1, wherein said frame at a longitudinally arranged beam at its right side and/or at its left side thereof comprises an auxiliary actuator having a first end and a second end, such as a hydraulic actuator or an electric actuator; said auxiliary actuator is being configured to be able to change its configuration between a compressed configuration and an expanded configuration and vice versa, by actuation thereof;
wherein said frame at said longitudinally arranged beam at its right side and/or at its left side thereof comprises a pivoting element; wherein said pivoting element is being mounted onto an inner side of said longitudinally arranged beam of said frame so as to be able to pivot around a pivoting axis; wherein said pivoting element comprises a push portion;
wherein said first end of said auxiliary actuator is being pivotally fastened to said frame and wherein the second end of said auxiliary actuator is being pivotally fastened to said pivotally element in such a way that in a situation where the longitudinal front end is in its lowered configuration, then a change in configuration of said auxiliary actuator from its compressed configuration to its expanded configuration will allow said push portion of said pivoting element, such as either directly or indirectly, to push onto said wheel suspension in a downward direction, thereby aiding the actuator in its initial movement upon lifting said support surface in relation to the ground surface; optionally wherein said push portion of said pivoting element comprises a roller for providing contact with said wheel suspension.

32. (canceled)

33. A towing device according to claim 31, wherein said control system is being configured for receiving input from an operator; and wherein said control system, based on said input, is being configured to provide control instructions to said auxiliary actuator for control thereof.

34. A towing device according to claim 1 further comprising one or more auxiliary wheel assemblies, such as one or two auxiliary wheel assemblies, wherein said wheel suspension, at a lower side thereof comprises one or more receiving organs for detachably mounting said auxiliary wheel assembly/assemblies; wherein said auxiliary wheel assembly comprises a wheel frame and one or more auxiliary wheels, such as one or two auxiliary wheels; wherein in respect of one or more of said auxiliary wheel assemblies, said auxiliary wheel(s) is/are mounted on its associated wheel frame so as to be able to rotate in relation to said wheel frame; wherein said wheel frame comprises a wheel frame engagement means, wherein said wheel frame engagement means is being configured to be able to detachably engage with said receiving organ of said wheel suspension; optionally wherein said receiving organ(s) of said wheel suspension and said wheel frame engagement means of said wheel frame together forms a click-on coupling system, such as being in the form of a Variobloc RO 100.

35. (canceled)

36. (canceled)

37. Use of a towing device according to claim 1 for moving a vehicle from one location to another location.

38. (canceled)

39. A method for moving a vehicle from a first location to a second location;
said method comprises the steps of:
i) providing a towing device according to claim 1;
ii) arranging the towing device in line with the longitudinal direction of the vehicle to be moved, either in front of or behind that vehicle;
iii) ensuring that the support platform is being arranged in a lowered configuration;
iv) using said control system of said towing device to propel and steer said device in order to arrange said support surface, or at least part thereof, of the towing device, below said vehicle to be moved;
v) once arranged below said vehicle to be moved, via said control system, raising said support surface a predetermined distance by means of said lifting means;
vi) using said control system of said towing device to propel and steer said towing device in order to move said vehicle from said first location to said second location.

40. (canceled)
